(19) United States
(12) Patent Application Publication
(10) Pub. No.: US 2014/0126702 A1
(43) Pub. Date: May 8, 2014

(54) X-RAY EMITTER

(71) Applicants: Werner Haag, Lugnorre (CH); Toni Waber, Aefligen (CH); Hans-Rudolf Elsener, Baar (CH); Benno Zigerlig, Untersiggenthal (CH); Dominique Cloetta, Villars-sur Glane (CH); Urs Hostettler, Thun (CH)

(72) Inventors: Werner Haag, Lugnorre (CH); Toni Waber, Aefligen (CH); Hans-Rudolf Elsener, Baar (CH); Benno Zigerlig, Untersiggenthal (CH); Dominique Cloetta, Villars-sur Glane (CH); Urs Hostettler, Thun (CH)

(73) Assignee: COMET HOLDING AG, Flamatt (CH)

(21) Appl. No.: 14/122,257

(22) PCT Filed: Jun. 8, 2011
(86) PCT No.: PCT/EP2011/059486

§ 371 Date: Nov. 26, 2013

(51) Int. Cl. H01J 35/08; H01J 35/12

(52) U.S. Cl. CPC H01J 35/08; H01J 35/12
USPC 378/140; 427/123

(57) ABSTRACT

An X-ray emitter is suitable for evenly sterilizing large volumes of material in a short time, the emitter having an elongated X-ray target window and correspondingly elongated electron source mounted in a vacuum chamber. The electrons from the electron source are accelerated towards the X-ray target window, which generates X-rays directed outward from the vacuum chamber when irradiated by electrons from within the vacuum chamber. The elongated form of the electron source ensures that an evenly distributed beam of electrons, with a substantially constant linear distribution over the length of the electron source, arrives at the elongated X-ray target window such that a correspondingly even distribution of X-rays is generated from the X-ray target window. The X-ray target window includes a support substrate, and carries an X-ray target layer made of a target material such as tantalum or tungsten on its inner surface. A process for manufacturing the X-ray emitter is also described.

### BACKGROUND AND SUMMARY

The present invention relates to X-ray emitting devices, also known as X-ray emitters or X-ray tubes. In particular, the invention relates to high energy X-ray emitters which can be used, for example, for sterilizing objects by irradiating them with intense doses of X-rays.

X-ray irradiation is commonly used for sterilizing such items as packaging, medical instruments, medical implants, blood for transfusions, or food products such as fruit. X-radiation is particularly suitable for sterilising or pasteurizing objects, because X-rays are not only highly ionizing, but also because they can penetrate deep into the object being treated.

Human blood plasma for transfusions, for example, can be treated by exposure to a dose of approximately 25 Gy of X-ray radiation (1 gray is defined as 1 joule of ionizing radiation energy per kilogramme of irradiated matter). This is roughly five times the amount of radiation which would be fatal to a human. Such radiation doses can be generated using isotopes such as Caesium-137 or Cobalt-60, or by using X-ray tubes. However, isotope sources are difficult to manage and regulate (they cannot be switched off), and they tend to produce an inhomogeneous spread of radiation, with the result that the different regions of the irradiated material receive varying doses of radiation. X-radiation is also attenuated as it penetrates the material being irradiated, which causes further variation of amount of irradiation in different parts of the volume being irradiated. In the ideal case, such variation should be eliminated entirely, with a max/min ratio of 1.0:1, but prior art systems have obliged operators to be content with max/min ratios of around 1.5:1 (or higher when the irradiated body is such that the radiation must pass particularly deep into the material).

X-ray tubes have been used, but have hitherto not been capable of generating satisfactory quantities of homogenous X-ray radiation unless used in arrays of multiple large tubes. Such arrays are unwieldy constructions, which still leave unsolved the problems of a) increasing the throughput of material to be irradiated, and b) producing a homogeneous distribution of irradiation energy.

A typical prior art irradiation process may involve the use of two 3 kW X-ray tubes to irradiate a volume of 1.5 litres of liquid, for example. Such an arrangement will provide an irradiation dose of around 4 Gy/minute (measured at the least irradiated point in the volume). Thus an irradiation time of 6 or 7 minutes is typically required in such an arrangement to achieve thorough irradiation of the volume. Using isotope sources requires similar irradiation times. These are slow irradiation rates, and usually represent a critical bottleneck in an irradiation process. It is desirable to provide an X-ray emitter which can provide, using a significantly reduced number of X-ray emitter units, a much greater and more homogenous irradiation of a volume (increased radiation intensity and improved radiation homogeneity both enable irradiation times to be reduced). It has been shown that, compared with existing devices, the X-ray emitter of the invention can irradiate twice the volume in half the time and with half the number of tubes.

An X-ray tube typically comprises a cathode electron source and an anode for accelerating electrons emitted from the cathode towards a target made of some suitable material which generates X-rays when bombarded by electrons. The tube also comprises an aperture, or window, through which the X-rays are emitted from the tube. Since the electrons emitted from the cathode travel to the target through a vacuum, the window is constructed to withstand the pressure differential between the vacuum inside the vacuum chamber and the space outside the chamber, while still allowing the free passage of X-rays out from the vacuum chamber.

An example of a prior art X-ray sterilizing system is described in U.S. Pat. No. 6,931,095, which attempts to solve the above problems by using a scanning electron beam which impinges on a conversion plate to generate a scanning (directional) X-ray output. The X-rays emitted can be modulated (for example by duty cycle) to compensate for the geometry of the X-ray emitter and/or the geometry of the object being irradiated. The solution proposed in U.S. Pat. No. 6,931,095 does go some way towards improving the homogeneity of the irradiation, but the system is complicated and unwieldy, and still does not address the problem of speeding up the sterilization process except insofar as it allows larger volumes to be irradiated at once, and therefore reduces the number of times which the objects to be irradiated must be moved. The X-ray emitters of U.S. Pat. No. 6,931,095 are also bulky, which imposes a physical limit on the number of devices which can be combined into one irradiation system.

The problem thus remains of how to generate larger doses of X-ray radiation using a more compact X-ray emitter, without losing the homogeneity of the irradiation distribution throughout the irradiated volume.

These and other problems with the prior art are solved by the present invention, which aims to provide an X-ray emitter comprising an electron source and an electron accelerator in a vacuum chamber, the electron accelerator being arranged to accelerate electrons from the electron source through the vacuum chamber to art X-ray target window, which generates X-rays directed outward from the vacuum chamber when irradiated by electrons from within the vacuum chamber, the electron source having an elongated form and being arranged to supply electrons with a substantially constant linear distribution over the length of the electron source, the X-ray target window having an elongated form, the electron accelerator being arranged to accelerate electrons, substantially evenly distributed over the length of the elongated electron source, such that the electrons thereby accelerated arrive at the elongated target window substantially evenly distributed over the length of the elongated target window, the X-ray target window comprising a support substrate bearing a target layer made of a target material which emits X-rays when hit by incident electrons from the electron source. By using an elongated electron source and a correspondingly elongated X-ray target window, the evenness of the irradiation can be maintained. By using an X-ray target which is combined with the window, the X-ray source can be brought into close proximity with the volume being irradiated.

According to a first embodiment of the X-ray emitter of the invention, the support substrate comprises a planar substrate sheet of a material substantially transparent to X-rays, the substrate sheet having sufficient structural strength that it can, supported only at the edge regions of the target window, resist the pressure differential between the inside of the vacuum chamber and the outside. The target material is adhered, fused or deposited on to the inward-facing surface of the substrate sheet. The substrate sheet comprises a sheet of copper, or an alloy comprising largely of copper, the sheet of copper being between 0.7 mm and 2 mm thick. Using a simple sheet of, for example, copper for the window results in a much simpler and more reliable construction.

According to a second embodiment of the X-ray emitter of the invention, the support substrate comprises a ribbed structure comprising openings through which the electrons from the electron source can pass to reach the target layer. In this embodiment, the target layer can comprise a foil of target material attached to the support substrate, or a foil of X-ray transparent material secured to the ribbed structure, with the target layer being secured to the inward-facing surface of the X-ray transparent foil. The X-ray transparent foil may be of copper, or an alloy comprising largely of copper, and between 0.1 and 0.5 mm thick. The target layer is adhered, fused or deposited on to the inward-facing surface of the foil.

According to a third embodiment of the X-ray emitter of the invention, the support substrate comprises at least one coolant channel. A plurality of coolant channels may be used, distributed at least across an area of the target layer exposed to bombardment by electrons from the electron source.

The target material may be one or more of tantalum, tungsten, or an amalgam or alloy containing tantalum or tungsten.

The respective lengths of the elongated electron source and the X-ray target window preferably differ from each other by less than 20%. This ensures an even and easily controllable energy transfer from the electron beam to the X-ray beam.

The invention also aims to provide a method of producing a target window for an X-ray emitter as described above, the method comprising a first step of forming a target window support substrate having sufficient structural strength that it can, supported only at the edge regions of the target window, resist the pressure differential between the inside of the vacuum chamber and the outside, and a second step of forming a target layer on the support substrate, the target layer being made of a target material which emits X-rays when hit by incident electrons from the electron source. The second step may include an offset printing process for depositing the target material on to the support substrate, or alternatively a process of preparing a powder mixture of target material with a fusable binder, spreading the mixture on the support substrate and then heating the mixture to fuse it to the support substrate.

### BRIEF DESCRIPTION OF THE DRAWINGS

The various embodiments and variants of the invention are described with reference to the accompanying drawings, in which:

FIG. 1 illustrates a perspective view of an X-ray emitter according to a first embodiment of the invention.

FIG. 2 illustrates a perspective sectional view of an X-ray emitter according to the first embodiment of the invention.

FIG. 3 illustrates a perspective view of an X-ray emitter according to a second embodiment of the invention.

FIG. 4 illustrates a perspective sectional view of an X-ray emitter according to the second embodiment of the invention.

FIG. 5 illustrates am exploded perspective sectional view of an X-ray emitter according to the second embodiment of the invention.

FIGS. 6 and 7 illustrate transverse and longitudinal cross sections respectively of the second embodiment.

FIG. 8 shows an exploded perspective sectional view of an X-ray emitter according to a third embodiment of the invention.

FIGS. 9 and 10 show sectional and perspective sectional views of the X-ray target window used in the third embodiment of the invention.

The figures are by way of example only, and are provided as an aid to understanding the invention. They should not be taken as limiting the claimed scope of protection in any way.

### DETAILED DESCRIPTION

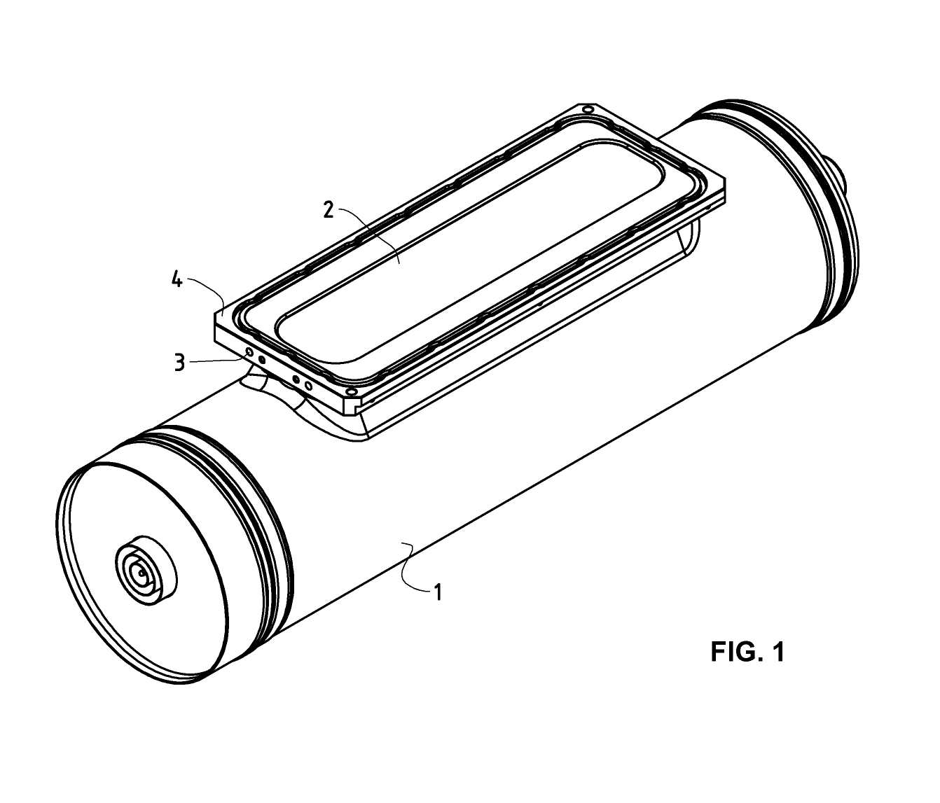

The X-ray emitter illustrated in FIG. 1 comprises a cylindrical vacuum chamber 1 and a side-window assembly 2, 4, through which the X-rays are to be emitted. Such a configuration is sometimes referred to as a transmission-target X-ray tube. In the X-ray emitter of the invention, the window 2 also serves to convert electrons emitted from the electron source (not shown in FIG. 1) which hit the internal surface of the window 2. Electrical connections to the X-ray emitter are provided at the end or ends of the cylindrical vacuum chamber, and coolant can be connected at coolant inlets/outlets 3. Note that this configuration, with that large elongated X-ray target window 2 located outside the main volume of the vacuum chamber, means that X-rays, which are generated at the target window, can be delivered to the volume to be irradiated in very close proximity.

Target and exit window are formed as one element, which means that the target (X-ray source) can be brought into close proximity with the volume to be irradiated. This in turn means that a much greater proportion of the potential X-ray flux can be used for irradiating the volume. The focal area of the X-rays can be made much larger (e.g. a window size of 27 cm by 4 cm as compared with just a few mm for prior art X-ray tubes), such that a much larger volume can be homogeneously irradiated with one X-ray emitter (i.e. can achieve significantly higher irradiation levels, or can achieve the same irradiation levels, but with fewer X-ray emitters or in a shorter irradiation time).

Furthermore, the elongated configuration of the X-ray emitter of the invention, unlike prior art emitters, permits the irradiation of an object on a turntable, for example, with the window of the X-ray emitter just a few millimeters from the object being irradiated.

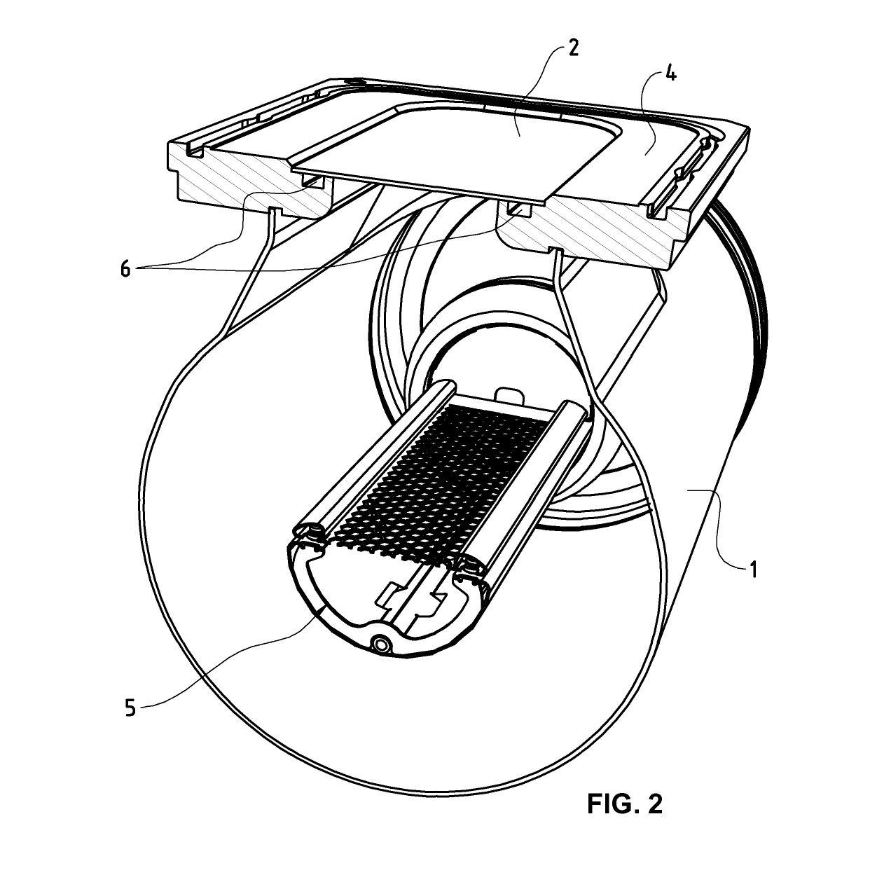

FIG. 2 shows a cross section through an X-ray emitter according to the invention. The figure shows the electron source assembly (which conventionally comprises a heated filament for heating an electron source material to release free electrons into the vacuum which are then accelerated towards the window 2). In the embodiment illustrated in FIG. 2, the window comprises a simple planar plate 2 of, for example, copper, or a copper-based alloy, mounted in a frame 4. Copper alloys containing small quantities of aluminium oxide ceramic particles are preferably used, as such alloys exhibit greater thermal stability, and the material does not soften or granulate at higher temperatures. If the grain size of the material begins to grow, this can lead to the material becoming permeable over time, thereby losing its ability to provide a good vacuum seal.

The inward facing surface of the copper or copper alloy sheet 2 (i.e. the surface facing towards the electron source 5) carries the target layer (not shown). The target layer is the material which, when irradiated by electrons, emits X-radiation out through the window 2. The target material may typically be tungsten or tantalum—deposited or printed on to the sheet, for example, in a thickness of a few microns.

Coolant channels 6 are also shown in FIG. 2. The window 2 inevitably gets hot when bombarded by large quantites of electrons from source 5. The channels 6 serve to circulate water, for example, around the edges of the window plate 2 in order to cool it. Running the X-ray emitter with a supply voltage of between 150 kV and 300 kV (typically around 180 kV or 200 kV), and a power consumption of between 2 and 6 kW, window temperatures may reach 150° C. or even 200° C., even with cooling applied at the window perimeter using channels 6 as shown in FIG. 2.

The window plate 2 may typically be between 0.5 mm and 3 mm, for applied voltages of 150 to 300 kV, in order to provide sufficient strength. The thicker the plate 2, the better the heat dissipation, and thereby the greater the possible operation power, but thicker plates also attenuate the X-rays more, thereby reducing efficiency. The thickness of the plate 2 must therefore be chosen to minimize the attenuation of the X-rays emitted through it, while still remaining strong enough to withstand the physical use and the pressure differential between the inside of the vacuum chamber 1 and the outside. The use of a 1 mm to 1.5 mm thick simple planar copper alloy plate 2, with no supporting structure, results in a simple but effective construction which offers a satisfactory balance between these requirements, for energies of 160 keV to 200 keV, while still delivering the significant irradiation intensity and evenness which have hitherto not been achievable with prior art devices.

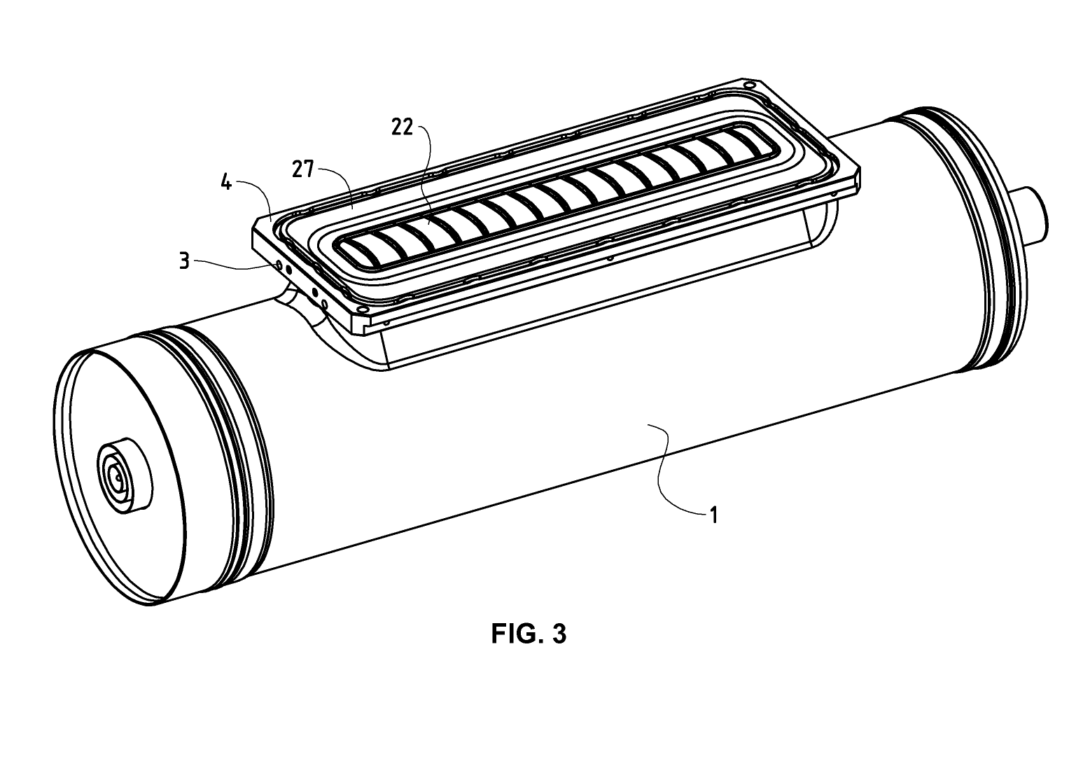

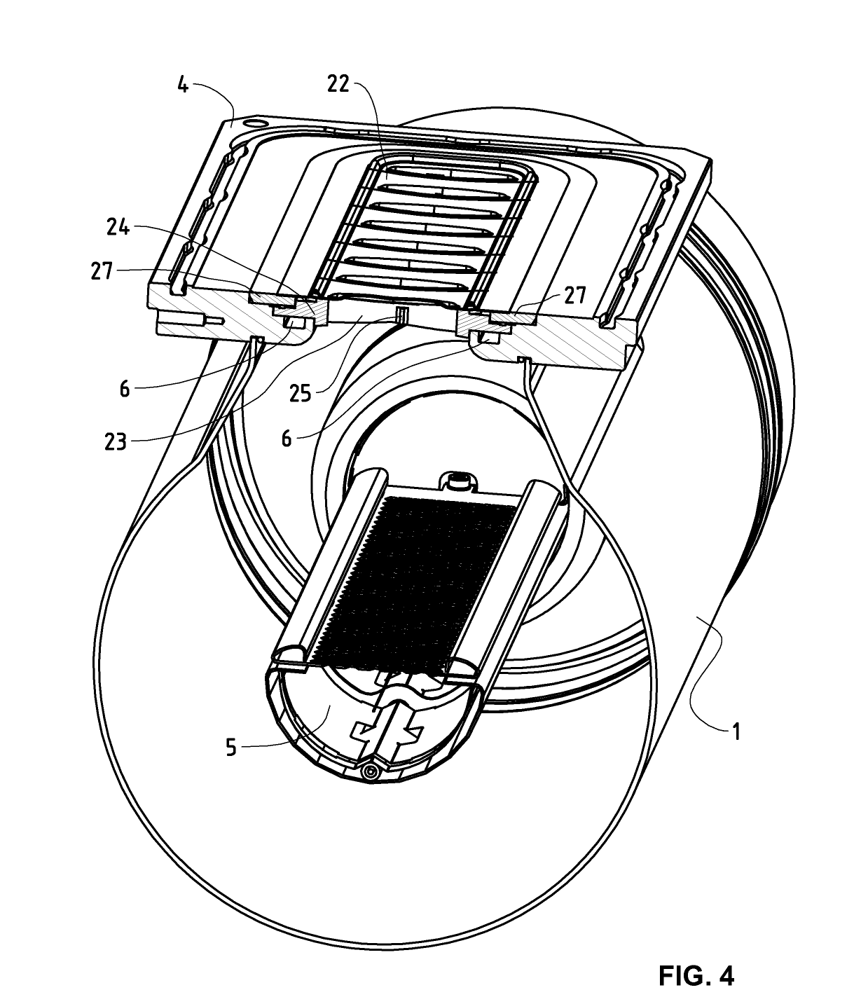

FIGS. 3 to 7 show various views of an X-ray emitter according to a second embodiment of the invention. In this embodiment, a thin target window sheet 22, which may, for example, be made of copper alloy coated on its inner surface with X-ray generating target material, is mounted (e.g. by welding or brazing) into a frame 27, which may be made of stainless steel, for example. The frame 27 is in turn mounted into the outer holder 4. A steel frame 27 is used in this embodiment because the target window 22 itself has little structural strength of its own, and can be more easily manipulated, without damaging it, once it is mounted in the steel frame 27. Similarly, because the sheet 22 itself is not strong, it requires support in order to resist the pressure difference between the vacuum inside the vacuum chamber 1 and the air outside. This support is illustrated in FIGS. 4 to 7, which show how a ribbed support member 24, comprising multiple transverse ribs 23, supports the thin metal (e.g. copper alloy) foil or sheet 22. The target layer of X-ray generating material is on the inner surface of sheet 22. The thin sheet may be between 0.1 and 0.5 mm thick—a 0.3 mm sheet of copper alloy is particularly suitable.

The window sheet 22 may be flat, or it may be provided with wave-like corrugations or other deformations at intervals, particularly along its length, in order to allow for thermal expansion or contraction of the sheet 22 during operation. While this option may be used in any of the embodiments of the invention, it is particularly relevant in this embodiment, since a thin sheet 22 is used, which offers the advantage of greatly reduced X-ray attenuation, but also reduced thermal dissipation and reduced structural strength in the sheet 22 itself.

The ribs 23 of the support structure 24 may typically be 3 or 4 mm apart, and 5 or 6 mm deep, and shaped to offer maximum structural support for and thermal dissipation from) the sheet 22 while offering minimum obstruction to the electrons arriving from the electron source 5. While ribs 23 are illustrated as a suitable support structure, it would also be possible to consider using other shapes of support structure such as a honeycomb or grid.

Support structure 23, 24 is designed in such a way that the transmission window base sheet 22 is in contact with the support structure 23,24 over the full area of the window 22. This ensures maximum support and maximum thermal dissipation.

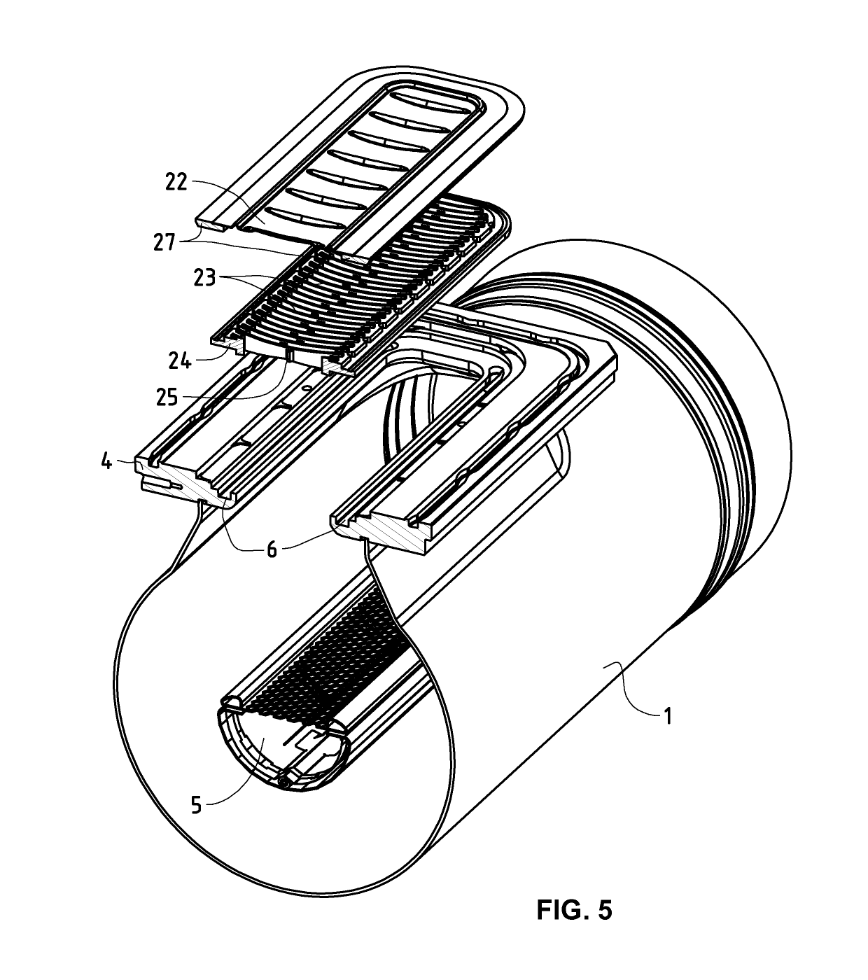

FIGS. 4 and 5 show perspective views of the example window structure of the second embodiment, and in particular the ribbed support structure 23, 24. Ribs 23 are shown with intersticial bridging supports 25 which give each rib 23, and the rib structure 24 as a whole, greater stability and structural strength by preventing movement or distortion of the ribs in the longitudinal direction. The bridging supports 25 illustrated are alternately staggered to provide additional structural rigidity in the support structure 24 as a whole.

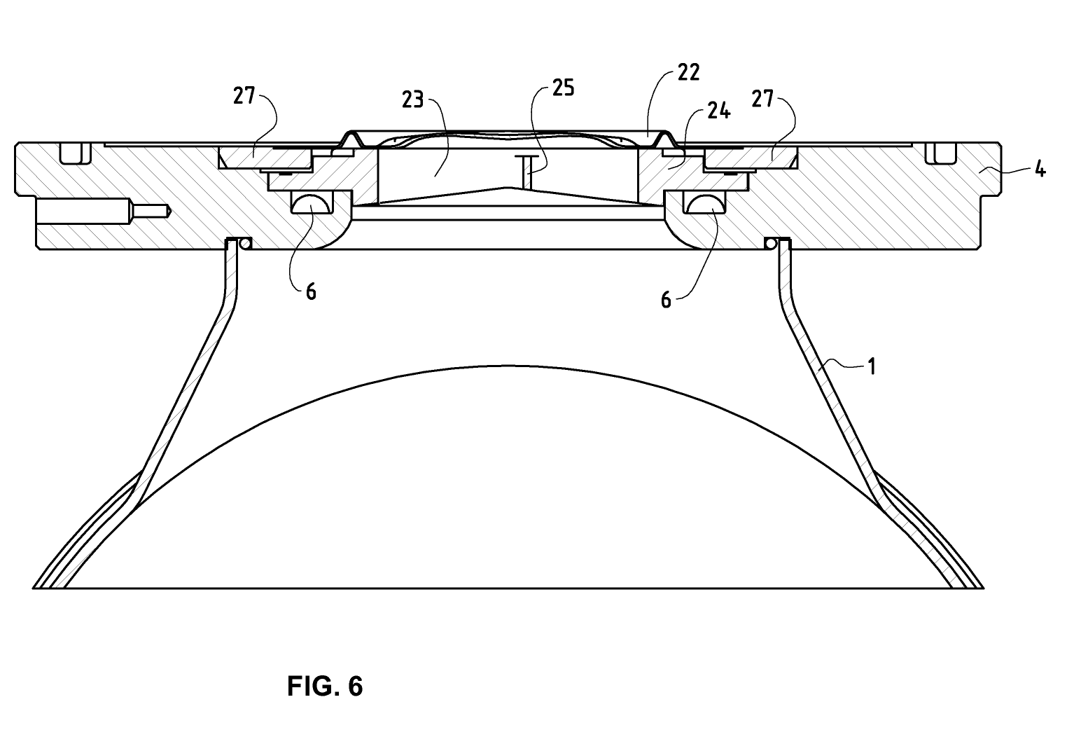

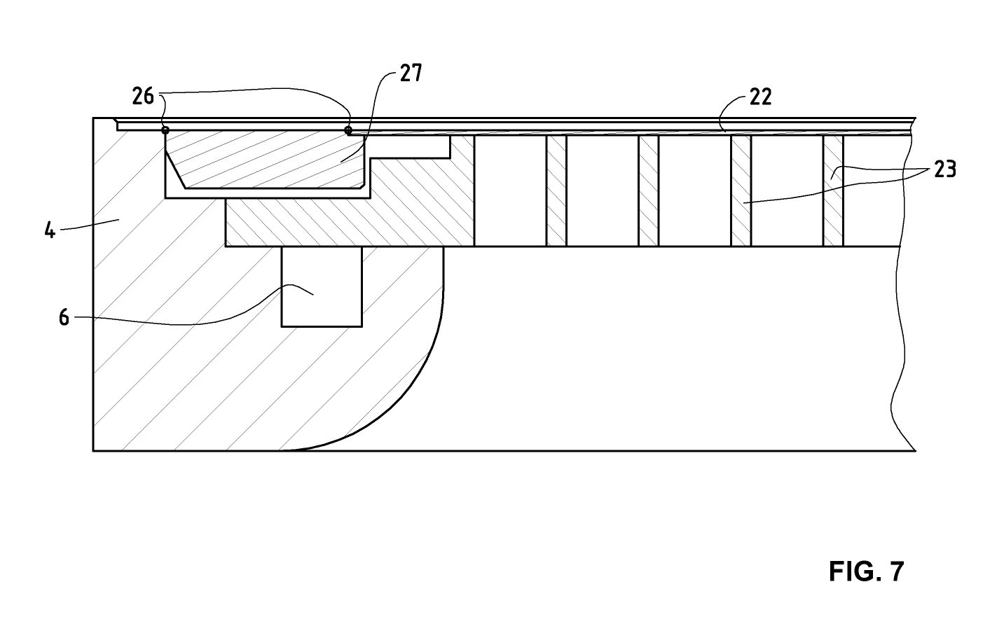

FIGS. 6 and 7 illustrate transverse and longitudinal cross sections of the second embodiment respectively.

FIG. 7 illustrates a part of a longitudinal section showing a closer detail in cross section of the the X-ray emitter of the second embodiment of the invention. In particular, the figure shows how the thin target window 22 is brazed or soldered to the stainless steel frame 27 (right-hand marking 26) and how the stainless steel frame is in turn laser-welded to the window holder (at the left-hand marking 26). The window sheet 22 rests on the outer surfaces of the ribs 23, and the assembly is cooled by coolant flowing through channel 6. As with other embodiments, a further layer of a corrosion-protective material (preferably nickel) may be added to the outside. This nickel layer may be around 2.5 μm thick to provide adequate corrosion protection without significantly attenuating the X-ray output.

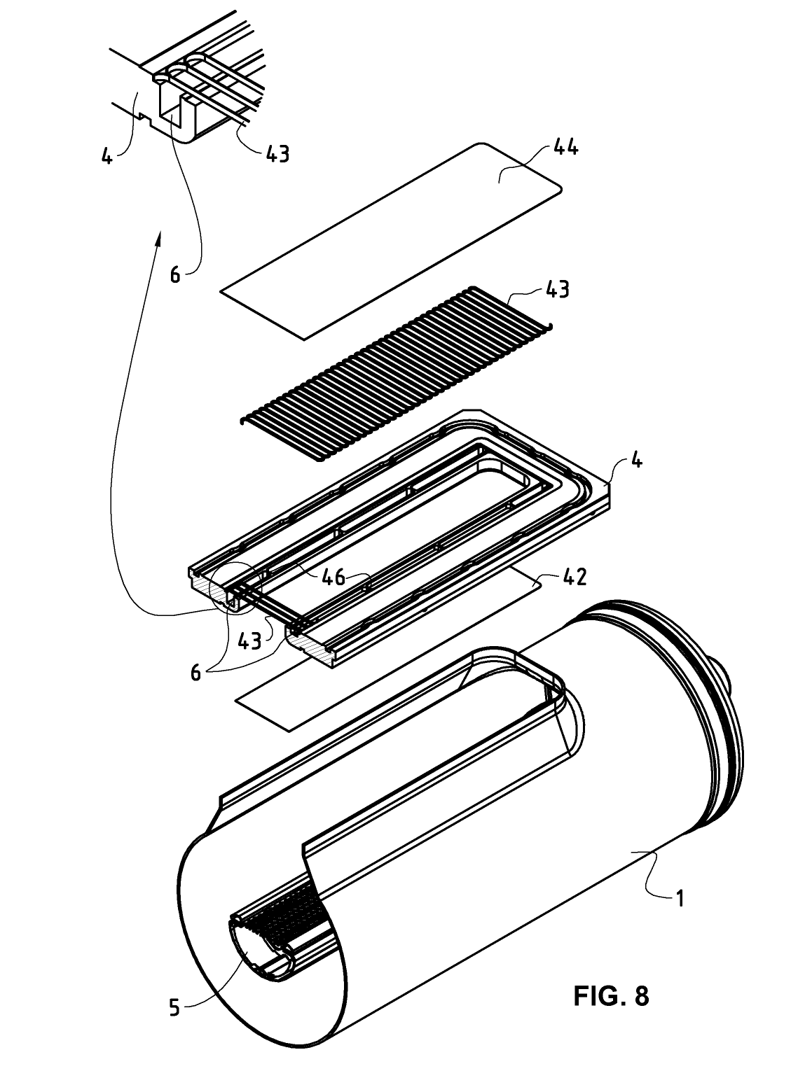

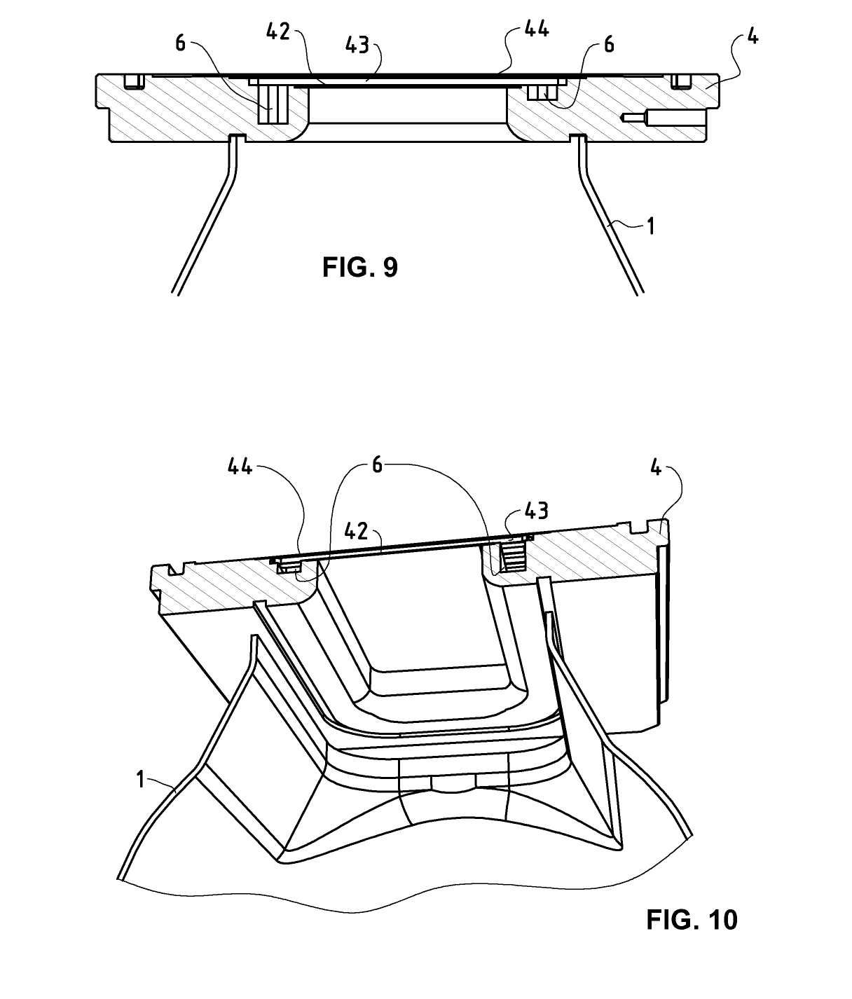

FIGS. 8 to 10 shows a third embodiment of the invention. In this embodiment, the target window is constructed as a “sandwich” formed by two planar sheets 44 and 42 with an array of cooling channels 43 in between, through which an X-ray transparent coolant (such as water or oil) can be pumped. Because the assembly is cooled, the thermal conductivity of the sheets 44 and 42 is no longer so critical, and it is possible to use stronger materials than copper, such as stainless steel. The steel sheets 42 and 44 may be thin (0.25 mm, for example), but the sandwich structure will still have sufficient structural strength to perform the required multiple roles of sealing the vacuum chamber, carrying the X-ray target coating and allowing the passage of X-rays with minimal attenuation. The coolant channels within the sandwich of the window may, for example, be 1 mm or 2 mm deep and 5 mm wide. The channels can be preformed, or assembled from many individual strips 43 welded or soldered together and/or to the sheets 44 and 42. The direction of flow of coolant may be alternated by means of barriers 46 in the side coolant channels 6, which direct the coolant in the desired parallel and serial combinations of channels. In an example with 54 channels, for instance, they may be arranged in nine groups of parallel channels, with the nine groups connected in series. Such combinations of parallel and series flow can be chosen to give optimum coolant flow through the window, and minimum backpressure in the coolant.

The target layer in each of the embodiments is mounted, adhered, deposited, spread, painted, or otherwise applied to the inner surface of the target window sheet. The layer may be a tungsten foil, for example, welded or adhered to the target window sheet, or it may be produced by sputtering tantalum onto the supporting sheet or foil. Tantalum offers significantly reduced stress in the layer at high temperatures during production, when compared with tungsten. Tantalum also adheres better to the supporting sheet or foil than does tungsten. Alternatively, the target layer may be produced by mixing a brazing compound with tungsten powder, spreading the mixture as a paste (or otherwise depositing the mixture on to the window substrate) and then heating it to melt the brazing material, thereby resulting in a solid target layer, containing evenly distributed tungsten particles, when cooled. For example, the paste may contain 30 to 50% (by vol.) of tungsten powder (for example of particle size <15 μm), with brazing powder (particle size <15 μm), a binder and additives as required. The tungsten powder can be supplemented or replaced by a fine tantalum powder (also <15 μm). The brazing powder may comprise a base alloy of vacuum-suitable copper and/or nickel with a melting point of between 400° C. and 1000° C. Alternatively, the brazing powder can comprise a suitable mixture of copper, tin, nickel, titanium and/or other metal powders having a particle size of 15 μm or less, which can be sintered or brazed together in situ.

The various components of the mixture are combined into a paste (tungsten/titanium powder, brazing powder, binder, additives) and applied directly to the substrate. The application may be carried out by means of an offset printing process, or by being spread directly on to the substrate, before being melted in a vacuum oven to produce the final target coating.

Alternatively, instead of being applied by a printing or spreading process, prepreg sheets impregnated with the fine powder can be prepared, cut to size and applied to the substrate. In this case, the metal powders (tungsten and/or tantalum and brazing material with a particle size of less than 15 μm) are distributed evenly (optionally on a fluidized bed) on to a substrate covered with binding agent. The powder layer (or multiple powder layers) are then compressed, pre-tempered and mechanically re-compressed to form prepregs which can then (preferably having been pre-sintered) be glued or brazed to the target substrate and melted in the vacuum oven.

The surface of the melted target layer can then be finished mechanically by polishing, for example, or by melting a final thin finishing layer on to the surface. The thickness of the target layer should ideally be between 5 and 30 μm to generate the required quantity of X-rays, although layers of other thicknesses may also be used.

The elongated form of the electron source and the target window (the length to width ratio of the target window is at least 3:1, and preferably 5:1 or more), and the homogeneity of the X-ray output along the longitudinal axis of the target window, a much greater irradiation efficiency can be achieved by the X-ray emitter of the invention. For example, the variant with the ribbed support substrate (the second embodiment) may be used to irradiate a cylindrical container 150 mm tall and 150 mm in diameter with a volume of 2.7 litres rotating on a turntable, with the target window of the X-ray emitter located 20 mm from the surface of the cylindrical container. The X-ray emitter generates X-radiation at 180 keV and has a power rating of 4 kW. This example setup is capable of irradiating the cylindrical volume at 15 Gy/min with just one X-ray emitter, and with a min/max ratio of close to 1 0:1. An irradiation time of 100 seconds would be required to irradiate such a container of human blood, for example. This is markedly better than the irradiation rates possible with conventional X-ray tubes, in which an array of tubes having a similar total power rating would require 10 minutes or more to achieve the same exposure of the same volume.

1. X-ray emitter comprising:
an electron source in a vacuum chamber, arranged such that electrons from the electron source can be accelerated through the vacuum chamber towards an X-ray target window,
the X-ray target window being arranged to generate X-rays directed outwardly from the vacuum chamber when the X-ray target window is irradiated by electrons from within the vacuum chamber,
the electron source having an elongated form and being arranged to supply electrons with as substantially even distribution over the length of the electron source,
the X-ray target window having an elongated form,
the electron source and the X-ray target window being arranged to accelerate electrons from the electron source, towards the elongated X-ray target window, such that electrons arriving at the X-ray target window are substantially evenly distributed over the length of the elongated X-ray target window,
the X-ray target window comprising a support substrate bearing a target layer made of a target material which emits X-rays when irradiated by incident electrons from the electron source.

2. X-ray emitter according to claim 1, wherein the support substrate comprises a planar substrate sheet of a material substantially transparent to X-rays, the substrate sheet having sufficient structural strength that it can, supported only at its edge regions, resist the pressure differential between the inside of the vacuum chamber and the outside.

3. X-ray emitter according to claim 2, wherein the target layer is adhered, fused or deposited on to the inward-facing surface of the substrate sheet.

4. X-ray emitter according to claim 2, wherein the substrate sheet comprises a sheet of copper, or an alloy comprising largely of copper, the sheet of copper being between 0.7 mm and 2 mm thick.

5. X-ray emitter according to claim 1, wherein the support substrate comprises a ribbed structure comprising openings through which the electrons from the electron source can pass to reach the target layer.

6. X-ray emitter according to claim 5, wherein the support substrate comprises a window sheet of material substantially transparent to X-rays, the window sheet being supported by the ribbed structure, and the window sheet having the target layer on its inward-facing surface.

7. X-ray emitter according to claim 6, wherein the window sheet is a sheet of copper, or an alloy comprising largely of copper, and wherein the window sheet is between 0.1 and 0.5 mm thick.

8. X-ray emitter according to claim 6, wherein the target layer is adhered, fused or deposited on to the inward-facing surface of the sheet.

9. X-ray emitter according to claim 1, wherein the support substrate comprises at least one coolant channel.

10. X-ray emitter according to claim 9, wherein the support substrate comprises a plurality of coolant channels (43), and wherein the plurality of coolant channels (43) are distributed at least in an area of the X-ray target window exposed to incident electrons from the electron source.

11. X-ray emitter according to claim 1 wherein the target material is chosen from one or more of tantalum, tungsten, or an amalgam or alloy containing one or more of tantalum or tungsten.

12. Method of producing a target window for an X-ray emitter having the features of claim 1, the method comprising:
a first step of forming a target window support substrate having sufficient structural strength that it can, supported only at its edge region, resist the pressure differential between the inside of the vacuum chamber and the outside, and
a second step of forming a target layer on an inward-facing surface of the support substrate, the target layer comprising a target material which emits X-rays when exposed to incident electrons from the electron source.

13. Method according to claim 12, wherein the second step comprises a printing or spreading process for depositing the target material evenly on to the inward-facing surface of the support substrate.

14. Method according to claim 12, wherein the second step comprises preparing a powder mixture of target material with a fusable binder, applying the mixture to the support substrate and then heating the mixture to fuse it to the support substrate.

15. Method according to claim 14, wherein the powder mixture includes at least 30% tungsten or tantalum powder.
